(19) United States
(12) Patent Application Publication
(10) Pub. No.: US 2017/0169908 A1
(43) Pub. Date: Jun. 15, 2017

(54) METHOD FOR PRODUCING BETA EMITTING RADIOPHARMACEUTICALS, AND BETA EMITTING RADIOPHARMACEUTICALS THUS OBTAINED

(71) Applicant: ISTITUTO NAZIONALE DI FISICA NUCLEARE, Frascati (RM) (IT)

(72) Inventor: Alberto ANDRIGHETTO, Legnaro (PD) (IT)

(73) Assignee: ISTITUTO NAZIONALE DI FISICA NUCLEARE, Frascati (RM) (IT)

(21) Appl. No.: 15/115,635

(22) PCT Filed: Dec. 18, 2014
(86) PCT No.: PCT/IB2014/067093

§ 371 Date: Jul. 29, 2016

(30) Foreign Application Priority Data
Jan. 31, 2014 (IT) MI2014A000145

(51) Int. Cl. G21G 4/08; G21G 1/00; G21G 1/02

(52) U.S. Cl. CPC G21G 4/08; G21G 1/02; G21G 1/001; G21G 2001/0094

(57) ABSTRACT

The present invention relates to a method for producing beta emitting radiopharmaceuticals. The method provides to produce, through a primary accelerator, a low energy proton beam, namely with an energy lower than 70 MeV, preferably with an energy ranging from 32 to 45 MeV, more preferably with energy ranging from 38 to 42 MeV; the low energy proton beam is irradiated on a source target so as to generate a neutral atom beam; the neutral atoms are ionized, extracted by acceleration and preferably subjected to a first focusing; the first focused beam is subjected to a mass separation such to generate a isobaric beam of radioisotopes. The isobaric beam therefore is preferably subjected to a second focusing and it is sent for a predetermined time on a deposition target. Then the irradiated deposition target is subjected to chemical treatment so as to obtain pure beta emitting radiopharmaceuticals.

### TECHNICAL FIELD

The present invention relates to the field of the production of neutron-rich radiopharmaceuticals, or beta emitting radiopharmaceuticals, particularly pure beta emitting radiopharmaceuticals by means of pure nuclear fission processes.

Particularly the present invention relates to the production of neutron-rich radiopharmaceuticals, or pure beta emitting radiopharmaceuticals, having a high specific activity (in the order of 25-30 kCi/g, equivalent to 925*10³-1,110*10³ GBq/g).

The present invention preferably, but not exclusively, is directed to the production of carrier-free strontium-89.

### PRIOR ART

The term “radiopharmaceuticals” means medicinal preparations made of radioactive isotopes (radionuclides) having such chemical-physical-biological properties that allow them to be administered to the human being for diagnostic or therapeutic purposes.

Particularly a radiopharmaceutical administered to a patient causes the introduction into the organism of a source of radiation that can be detected from the outside by the use of suitable instruments or that can cause the death of tumor cells after localization into specific sites.

For in vivo diagnostic procedures the radioisotopes used usually emit γ (gamma) rays, which have a low coefficient of absorption by the tissues and have a suitable energy to allow them to be measured by the medical-nuclear instruments that are usually employed.

As regards therapeutic purposes it is preferred to use radioisotopes emitting a (alpha) and β (beta) rays, which are absorbed almost completely by thin biologic structures (few microns or few millimeters at most); particularly it is preferred to use beta+ and beta− rays, which are different as regards different interactions with the tissues.

The therapeutic use of radiopharmaceuticals is based on the fact that the radiopharmaceutical administered to the patient, by concentrating in pathologic tissues as it is similar or due to low diffusivity, can irradiate and destroy them, therefore it is important for the radiopharmaceutical to dissipate all its energy in a very small space (smaller than 1 cm), such to allow a selective metabolic and focused radiotherapy (generally the alpha-emitting ones, due to their high linear transfer of energy and due to the short path length, are more suited to hit hematopoietic cells, while the beta-emitting ones, due to their lower energy and to the longer path length, are more suited to hit solid and large tumors).

For clinical purposes the specific activity of the administered radiopharmaceutical is of primary importance: “specific activity” is defined as the concentration of the activity per mass of the element. The “activity” is the number of decays experienced by the core of the isotope in one second (the activity, on the contrary, does not mean the amount of energy emitted by each decay); a specific activity is defined as “low” in the order of 0.5-1 Ci/g (equivalent to 18.5-37 GBq/g), while a specific activity is defined as “high” in the order of 25-30 kCi/g (equivalent to 925*10³-1,110*10³ GBq/g). Low values of specific activity are caused by the presence in the radiopharmaceutical of stable isotopes of the same element; clinically relevant radioisotopes indeed can be diluted by admixtures of stable isotopes of the same element without any therapeutic effect due to production limits. Radiopharmaceuticals without these kinds of impurities are called carrier-free, differently from carrier-added ones.

Radionuclides employed for therapeutic and diagnostic purposes are artificially produced by means of nuclear reactors, radionuclide generators or cyclotrons.

Specifically, the production of beta-emitting radiopharmaceuticals is currently performed by using nuclear reactors; such technique however has the drawback of producing radiopharmaceuticals with a low specific activity (in the order of 0.5-1 Ci/g, equivalent to 18.5-37 GBq/g).

For the production of radionuclides it is also known, from the International application published with n. WO 2006/074960 A1, to use ISOL techniques that provide the generation of isotopes from a source target bombarded with a proton beam, and then the on-line separation of isobar beams to be directed on a destination target from where radionuclides are extracted.

In details, the International Application published with n. 2006/074960 A1 describes a method for the large scale production of radioisotopes by means of a number of unit operations which are selected and combined according to the sequence suitable for each individual radioisotope production scheme; these unit operations can be further combined, if necessary, with radiochemical methods for obtaining a specific product.

WO 2006/074960 describes some methods that provide the activation of the target by means of a particle beam with an energy variable depending on the desired product, distinguishing, on a physical phenomenology basis, those with an energy lower than 30 MeV and those with an energy higher than 50 MeV. In the case of the first type of methods with energy lower than 30 meV, described in the embodiment III, a source target of molten bismuth is irradiated by alpha particles with an energy ranging from 27.5 to 30 MeV, the energy range is selected in order to avoid the production of disturbing contaminations. In other cases, of the second type of methods with energy higher than 50 MeV, different source targets will be irradiated with high energy particles (higher than 50 MeV) that lead to the nuclear reaction known as “spallation”; in these cases, the use of beams with a lower energy is not recommended since it would not produce spallation and it would lead to the production of undesired products.

The mentioned document WO 2006/074960 does not describe methods and does not report examples in the energy value ranges higher than 30 MeV and lower than 50 MeV, more precisely from 32 to 45 MeV, still more precisely from 38 to 42 MeV.

The spallation reaction particularly is used for producing strontium-82 by using proton beams with an energy higher than 70 MeV and it has the drawback of unavoidably producing amounts of strontium-85 that are 3-5 times higher, an isotope contaminating the desired strontium-82 product (see the embodiment V- second variant of WO 2006/074960).

The inventors have noted that the several production methods known in WO 2006/074960 however are not efficient in producing pure beta emitting radioisotopes, such as strontium-89 (⁸⁹Sr₃); moreover the same methods allow specific activity values to be obtained with are still very moderate, at most equal to 30 mCi/mg (equivalent to 1.11 GBq/mg).

Therefore there is the unsatisfied need for providing a method for producing neutron-rich radiopharmaceuticals, or pure beta emitting radiopharmaceuticals, having a high specific activity (in the order of 25-30 kCi/g, equivalent to 925*10³-1,110*10³ GBq/g).

### OBJECTS AND SUMMARY OF THE INVENTION

It is the object of the present invention to overcome the drawbacks of the prior art.

Particularly it is the object of the present invention to provide a method efficient for producing pure beta emitting radiopharmaceuticals, specifically by pure fission nuclear processes.

It is also an object of the present invention a method for producing pure beta emitting radiopharmaceuticals having a high specific activity, particularly higher than 1 kCi/g (equivalent to 37*10³ GBq/ g); in particular the method allows the production of carrier-free radiopharmaceuticals.

These and other objects of the present invention are achieved by a method embodying the characteristics of the annexed claims, which are an integral part of the present description.

The inventors have found particularly advantageous conditions, above all as regards efficiency and cheapness aspects, to obtain pure beta emitting radiopharmaceuticals by means of an ion beam coming from a target producing ISOL. In details, the inventors have found that by irradiating the source target with a ion beam, particularly protons, with an energy lower than the minimum energy for producing products by spallation, namely with an energy lower than 70 MeV, preferably ranging from 32 to 45 MeV, and more preferably from 38 to 42 MeV, it is possible to obtain from the source target a ion beam particularly suitable for the production of pure beta emitting radiopharmaceuticals. Particularly by such particular selection, it is possible to obtain for example from an uranium dicarbide target dispersed in a graphite substrate UCₓ, radioisotopes with an atomic number ranging from 60 to 160 obtained by processes of pure fission, such as for example strontium-89 (⁸⁹Sr₃). These radioactive isotopes, suitably mass-selected and accelerated, can be implanted in a destination target and converted into drugs, potentially ready for the administration, by means of following chemical processes, such as the dissolution of the target in water or the treatment of the target with suitable chemical reagents.

Advantageously, the activation current of the primary accelerator is within the range 100-250 microA, and preferably in the range 100-200 microA. These currents are particularly advantageous since are able to sustain and dissipate the power from the target without melting it.

Further advantageous characteristics of the method are the subject matter of the annexed claims which are an integral part of the present invention.

The invention further relates to radiopharmaceuticals obtained by the method shown above and better described below.

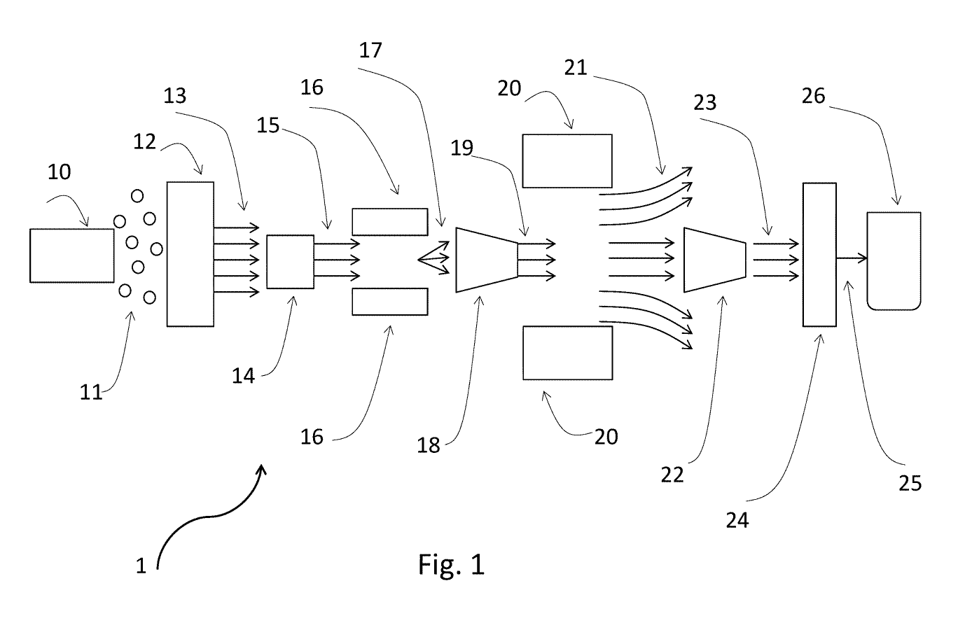

The present invention, together with its objects and advantages, will be clearer from the detailed description below: the description relates indeed to preferred embodiments of the method for producing pure beta emitting radiopharmaceuticals and relevant pure beta emitting radiopharmaceuticals obtained by said method exclusively claimed herein, given by ways of example and indication, but not as a limitation, with reference to the annexed FIG. 1. This image is provided only by way of example too, wherein an apparatus for carrying out the method according to the invention is schematically shown.

Such image shows different aspects and embodiments of the present invention.

### DETAILED DESCRIPTION OF THE INVENTION

While the invention is susceptible of various modifications and alternative forms, some non-limiting embodiments, provided for explicatory purposes, are described below in detail.

It should be understood, however, that there is no intention to limit the invention to the specific embodiments disclosed, but, on the contrary, the intention of the invention is to cover all modifications, alternative constructions and equivalents falling within the scope of the invention as defined in the claims.

Therefore in the description below the use of “for example”, “etc”, “or”, “otherwise” indicates non-exclusive alternatives without limitation unless otherwise defined; the use of “also” means “including, but not limited to” unless otherwise defined; the use of “including/comprising” means “including/comprising but not limited to,” unless otherwise defined.

The expression “chemical unit” means an apparatus or a system where a chemical reaction or a series of chemical reactions take place; particularly such expression herein means a radiochemistry laboratory with devices dedicated to the production of radiopharmaceuticals.

The expression “pure beta emitting” means radioisotopes that are subjected only to beta decays or radioisotopes that are subjected to beta decays and to not more than 10-11% of gamma-decays, preferably values of gamma-decays lower than 5%, and more preferably values of gamma-decays lower than 2%.

FIG. 1 shows the apparatus 1 employed for carrying out the method according to the present invention, which has optimal characteristics for producing pure beta emitting radiopharmaceuticals, particularly the radiopharmaceutical based on the isotope of strontium of mass 89.

Said apparatus 1 comprises:
a primary accelerator, or driver, 10,
a source target 12,
a ionizer 14,
an accelerator extractor 16,
preferably a first focusing equipment 18,
a mass separator 20,
preferably a second focusing equipment 22,
a deposition target 24, and
a chemical unit 26.

The primary accelerator 10, preferably an accelerator of the LINAC type (LINear ACcelerator) or cyclotron, has to produce low energy proton beams 11, namely with an energy lower than 70 MeV, preferably with an energy ranging from 32 to 45 MeV, more preferably from 38 to 42 MeV, and with beam currents of about 100-250 microA, preferably of about 100-200 microA.

In the energy range mentioned above, the processes at the basis of the isotopic production in the target have to be considered as pure fission ones; spallation phenomena, producing alpha-emitting isotopes, are not present in this energy range, thus improving the production efficiency of the method according to the present invention.

The choice of the operating current of 100-250 microA is due to the fact that the dissipation of the thermal power, equal to about 8-12 kW, conveyed to the source target can take place without the risk of melting the target itself.

A source target 12 is irradiated with the low energy proton beam 11 so as to generate a neutral atom beam 13. The neutral atoms produced 13 are then ionized, extracted by acceleration and preferably subjected to a first focusing; the first focused beam 19 is subjected to a mass separation in order to generate an isobaric beam 21 of radioisotopes; the isobaric beam 21 is therefore preferably subjected to a second focusing and sent for a predetermined time onto a deposition target 24; the irradiated deposition target 25 is then subjected to chemical treatment so as to obtain pure beta emitting radiopharmaceuticals.

It has to be noted that said first and second focusing, optional although preferred, allow the efficiency of the production method according to the present invention to be further increased.

The reaction products are extracted from the source target 12 by sublimation at a very high temperature, at about 1,800-2,000° C. they are ionized (charge state 1+) in the ionizer 14 and then mass selected in the mass separator 20 in order to produce an isobaric beam of radioactive isotopes 21, such as for example pure fission isotopes 60-160. For such application the isotopes strontium-89, yttrium-90, iodine-125, iodine-131, xenon-133 and selenium-75 are interesting and more preferably strontium-89 among them, due to the high fission “rate”.

Preferably the source target 12 is constituted by a plurality of UCx discs (uranium dicarbide dispersed in a graphite substrate); more preferably the target has a lamellar structure (such arrangement allows a very high power to be used, thanks to the great capability to dissipate it).

In the case of an incident proton beam of 40 MeV of energy and 200 microA of current intensity, a preferred source target is composed of seven discs UCₓ with a diameter of 4 cm and a thickness of about 1 mm, which are suitably spaced from each other by about 1 cm in order to dissipate the average power of about 10 kW produced by the incident proton beam; said preferred source target further has a power density of about 800 W/cm³.

The source target 12 is connected, through a transfer tube (not shown) to the ionizing device 14.

The neutral atoms 13 produced by the source target 12 will spread, also thanks to the operating temperature, that is preferably equal to about 2,000° C., in the material of the source target before migrating to the ionizing device 14, where the atomic ionization will take place. In the ionizing device 14 the neutral atoms 13 are ionized, thus output ionized radioisotopes 15 are obtained from the device 14.

The ionizing device 14 can use any ionizing technique known per se, for example surface impact ionization (SIS), ionization of an electron-rich plasma (PIS) or ionization through laser beams (LIS); different techniques can be used for obtaining different ionization potentials.

The ionized isotopes 15 are sent to an accelerator extractor 16, preferably composed of electrostatic elements, wherein a potential difference of 20-40 keV is applied thereto; therefore output accelerated ionized isotopes 17 are provided.

The accelerated ionized isotopes 17 preferably are sent to first focusing equipment 18, such to produce a first focused beam 19; said first focusing equipment 18, optional although preferred, preferably comprises electrostatic lenses.

Said first focused beam 19 is sent to a mass separator 20 (of a type known in se), that provides different output isobaric beams. The isobaric beam (or beams) 21 of interest, for example those of isobars of ⁸⁹Sr₃, therefore will be preferably deflected and focused into second focusing equipment 22, optional although preferred. The deflection and focusing, optional although preferred, of the beam 21 of interest can be obtained by means of suitable electrostatic lenses so as to produce a second focused beam 23.

In the preferred embodiment, the mass separator 20 is arranged for selecting the isobars with a mass number ranging from 60 to 160, more preferably 89. Particularly the selected radioisotopes are the isotopes strontium-89, yttrium-90, iodine-125, iodine-131, xenon-133 and selenium-75.

As mass separator 20 it is possible to use magnetic dipoles or separators of the Wien filter type; the use, for example, of said Wien filter allows ions with the desired mass to be selected and transported along the beam line and the undesired ions to be deflected by suitable shutters.

After the extraction by acceleration, the first focusing (optional although preferred) and the mass selection, the isobaric beam (or beams) 21 is preferably subjected to a second focusing in second focusing equipment 22, such to produce a second focused beam 23 that in turn is sent onto a deposition target 24 placed inside a vacuum chamber preferably maintained with a pressure lower than 10⁻⁵ mbar.

The deposition target is irradiated for an irradiation period from some days to some weeks.

Then the irradiated deposition target 25 is extracted from the vacuum chamber and carried into a chemical unit 26, particularly a radiochemistry laboratory to perform, in a chemical device (of the “glove box” type) the extraction and purification operations necessary for producing pure beta emitting radiopharmaceuticals.

By summarizing what described above, the method for producing pure beta emitting radiopharmaceuticals by pure nuclear fission processes according to the present invention comprises the steps of:
i. producing a low energy proton beam 11, namely with an energy lower than 70 MeV, preferably with an energy ranging from 32 to 45 MeV, more preferably from 38 to 42 MeV, through a primary accelerator 10;
ii. irradiating said low energy proton beam 11 on a source target 12 so as to generate, thanks to the reaction of pure nuclear fission, a neutral atom beam 13;
iii. subjecting the neutral atoms produced and spread by the target 13 to a positive ionization with charge +1 through a ionizer 14 so as to produce an ionized radioisotope beam 15;
iv. accelerating said ionized radioisotope beam 15 in an accelerator extractor 16 so as to produce an accelerated ionized isotope beam (17) with an energy of 20-40 keV;
v. preferably subjecting said accelerated ionized isotope beam 17 to a first focusing in a first focusing equipment 18 such to produce a first focused beam 19;
vi. separating said first focused beam 19 in a mass separator 20 so as to generate an isobaric beam of radioisotopes (21) with a specific mass;
vii. preferably subjecting said isobaric beam of radioisotopes 21 to a second focusing in second focusing equipment 22 to produce a second focused beam 23;
viii. irradiating said second focused beam 23 on a deposition target 24 for a predetermined time so as to produce an irradiated deposition target (25);
ix. after said predetermined time, sending said irradiated deposition target 25 to an extraction and purification chemical treatment in a chemical unit 26, particularly a dedicated chemical laboratory so as to obtain pure beta emitting radiopharmaceuticals.

Preferably the proton beam is selected with beam currents of about 100-250 microA, more preferably of about 100-200 microA to allow the thermal power developed in the system composing the source target to be dissipated in a simpler and cheaper manner.

The method for producing pure beta emitting radiopharmaceuticals according to the present invention such as described above allows radiopharmaceuticals having a specific activity with a value within the range of 25-30 kCi/g (equivalent to 925*103-1,110*103 GBq/g) to be obtained.

The radioisotopes 13 produced in the source target 12 are pure fission isotopes, which makes the method particularly efficient. Preferably the isotopes selected for the production of radiopharmaceuticals are:
strontium-89 (t_{1/2}=50 days);
yttrium-90 (t_{1/2}=64 hours);
iodine-125 (t_{1/2}=60 days);
iodine-131 (t_{1/2}=8 days);
xenon-133 (t_{1/2}=5 days); and
selenium-75 (t_{1/2}=120 days). The most interesting one among these radioisotopes is strontium-89, both because of the production output (under the experimental conditions mentioned above it is about of 10⁷ isotopes per second) and because of its inherent decay properties (pure beta-emitting). Strontium-89 is a very important isotope for producing radiopharmaceuticals; particularly it has been used for many years in the treatment of bone cancer, but up to now its large scale production has been essentially obtained from nuclear power plants.

Among said radioisotopes another interesting isotope is yttrium-90 which is considered as the most important pure beta-emitting radionuclide for therapeutic applications.

A preferred arrangement according to the present invention for collecting the ions of strontium-89 coming from the accelerator 18 of said apparatus 1 consists in implanting the beam produced and selected in mass 89, such as described above, on the deposition target 20 housed in the vacuum chamber placed in the ending portion of the beam line for producing radiopharmaceuticals. It is important to note that all the radioactive isotopes produced by the fission of the uranium having mass 89 decay in a short time in the strontium isotope; therefore it is possible to obtain, after a waiting time of some hours, a very pure deposition of strontium-89.

This property makes it possible to obtain from the target a sample with a high specific activity of strontium-89.

Strontium-89 has a half-life of about 50 days and it decays to stable yttrium-89.

With reference again to the production of radiopharmaceuticals based on strontium-89, in one embodiment the beam of accelerated isotopes is sent on the deposition target for at least 2 days, so as to deposit in the deposition target a high amount of isobars with mass 89.

After such step of “production in-line”, the step of “extraction not in line (off-line)” of the radioisotope will begin; during such step the isotope is extracted from the deposition target that can be composed of a disc of graphite or a disc of NaCl.

The final step is the chemical process that will be applied to form strontium chloride SrCl₂, that is the chemical form that composes the radiopharmaceutical. This chloride is suitably diluted to obtain a physiological solution containing the radionuclide in the right concentration therefore ready for being administered to the patient.

In order to obtain the strontium chloride by using as the target a disc of graphite the technique for extracting the isotope foresees to immerge the graphite substrate, with the strontium implanted on its surface, into a water solution of hydrochloric acid. The immersion results in the reaction between the absorbed atoms Sr and HCl, according to the following reactions (neutral and ionic forms):

Sr+2HCl→SrCl₂+H₂

Sr(s)+2HCl(aq)→Sr²⁺(aq)+2Cl-(aq)+H₂(g)

The reaction of the graphite substrate with the solution does not take place since the graphite does not react with HCl, especially at low temperatures; therefore the only species that reacts with HCl is the deposited strontium.

The formed strontium chloride crystallizes in the cold water solution.

The presence of a water solution typically leads to the formation of SrCl₂ hexahydrate (SrCl₂.6H₂O) after removing the solvent.

A simpler alternative for extracting strontium chlorides is to send the beam of ions of strontium-89 onto a NaCl target.

After irradiation, the sodium chloride target, wherein in the previous days isobars of mass 89 have been implanted (which will all decay to radioactive strontium-89 and stable isotope yttrium-89), will be dissolved in a suitable amount of distilled water. Such process is necessary in order to obtain a physiological solution with a proper composition, therefore ready, after the relevant accurate quality and quantitative analyses, for being administered to the patient.

Yttrium-89 has no toxicity problems since it is a stable isotope and therefore it will be expelled from the organism.

The production, separation and use of isotope strontium-89 and the production of the relevant SrCl₂ are particularly interesting for different technical reasons, set forth below.

Firstly, the amount of strontium-89 produced in the source target (composed of seven discs UCx with a diameter of 4 cm and a thickness of about 1 mm, spaced from each other by about 1 cm in order to dissipate the average power of about 10 kW produced by the incident proton beam) is about 10¹⁵ atoms (integrated intensity after two days of irradiation of the UCx target by the nominal beam of 8 kW), an activity of about 18 mCi corresponding thereto.

Secondly, after a quite simple and efficacious mass separation, the isotope strontium-89 may be produced with a high purity level; the mass 89 has the following elements as contaminants: Rb, Kr, Br and Se, which have a very short half-life with respect to Sr, whose half time (t_{1/2}) is about 50 days; therefore after one hour wait in the substrate, wherein the ion beam of mass 89 is deposited, the elements present will be only strontium-89 (radioactive) and yttrium-89 (stable).

Thirdly, the chemical process for producing radioactive SrCl₂ is quite simple.

Fourthly strontium-89 is a pure beta-emitting (practically with no emissions of gamma rays); therefore it is easier to be handled than the other isotopes used for producing radiopharmaceuticals.

Finally the total produced activity of strontium-89 during an irradiation of 2 days allows up to 4-5 patients to be treated per week; with the standard dose (4 mCi each 6 months) it is possible to treat up to 120 patients a year.

The method according to the present invention for producing pure beta emitting radiopharmaceuticals, such as strontium-89 is simple and it allows a very high specific activity to be achieved: the production of a pure carrier of isotope strontium-89 has a specific activity of 28 kCi/g (equivalent to 1,036*10³ GBq/ g) than that of 0.5-1 Ci/g (equivalent to 18.5-37 GBq/g) of the same radiopharmaceutical obtained by using the standard methods with nuclear reactors.

The invention, in addition to the method described above, relates also to radiopharmaceuticals obtained by the method described above.

Particularly said radiopharmaceuticals have a specific activity having a value within the range 25-30 kCi/g (equivalent to 925*10³-1,110*10³ GBq/g).

Particularly, other characteristics of the radiopharmaceuticals produced by the method according to the present invention are:
contained gamma-emitting (impurities): 0%
contained strontium-90 (impurities): 0%

Although the invention herein has been shown, described and defined with reference to particular preferred embodiments, such references and embodiments set forth in the present description do not limit the invention in any manner; however it is clear that various modifications and changes may be made without departing from the broader scope of protection of the shown technical concept.

The preferred embodiments shown are merely by way of example and not as a limitation of the protection scope of the technical concept set forth herein; therefore the protection scope is not limited to the preferred embodiments described in the detailed description, but it is limited only by the claims below.

1-13. (canceled)

14. A method for producing pure beta emitting radiopharmaceuticals by pure nuclear fission processes comprising the steps of:
i. producing a low energy proton beam through a primary accelerator;
ii. irradiating said low energy proton beam on a source target so as to generate, thanks to the reaction of pure nuclear fission, a neutral atom beam;
iii. subjecting said neutral atom beam to a positive ionization in an ionizer so as to produce a ionized radioisotope beam;
iv. accelerating said ionized radioisotope beam in an accelerator extractor so as to produce an accelerated ionized isotope beam;
v. separating said accelerated ionized isotope beam in a mass separator so as to generate an isobaric beam of radioisotopes;
vi. irradiating said isobaric beam of radioisotopes on a deposition target for a predetermined time so as to produce an irradiated deposition target; and
vii. after said predetermined time, sending said irradiated deposition target to an extraction and purification chemical treatment in a chemical unit so as to obtain pure beta emitting radiopharmaceutical s,
wherein said low energy proton beam has an energy ranging from 32 to 45 MeV.

15. A method according to claim 14, wherein said low energy proton beam has an energy ranging from 38 to 42 MeV.

16. A method according to claim 14, further comprising, between steps iv. and v., the step of:
subjecting said accelerated ionized isotope beam to a first focusing in first focusing equipment so as to produce a first focused beam.

17. A method according to claim 14, further comprising, between steps v. and vi., the step of:
subjecting said isobaric beam of radioisotopes to a second focusing in second focusing equipment so as to produce a second focused beam.

18. A method according to claim 14, wherein said primary accelerator produces said low energy proton beam with beam currents of 100-250 microA, preferably 100-200 microA.

19. A method according to claim 14, wherein said source target comprises uranium dicarbide dispersed in a graphite substrate UCₓ.

20. A method according to claim 14, wherein said irradiation on said source target takes place at very high temperature, of the order of 2,000° C.

21. A method according to claim 14, wherein said neutral atoms produced in the source target are pure nuclear fission isotopes with mass numbers from 60 to 140.

22. A method according to claim 21, wherein said neutral atoms produced in the source target are the pure nuclear fission isotopes strontium-89 , yttrium-90, iodine-125, iodine-131, xenon-133 and selenium-75.

23. A method according to claim 14, wherein said isobaric beam of radioisotopes comprises strontium-89.

24. A pure beta emitting radiopharmaceutical obtained by means of the method according to claim 1, wherein the radiopharmaceutical comprises strontium-89 and has a specific activity in the range 25-30 kCi/g.

25. A pure beta emitting radiopharmaceutical comprising strontium-89 and having a specific activity value in the range 25-30 kCi/g.

26. A method according to claim 15, further comprising, between steps iv. and v., the step of:
subjecting said accelerated ionized isotope beam to a first focusing in first focusing equipment so as to produce a first focused beam.

27. A method according to claim 15 further comprising, between steps v. and vi., the step of:
subjecting said isobaric beam of radioisotopes to a second focusing in second focusing equipment so as to produce a second focused beam.

28. A method according to claim 26, further comprising, between steps v. and vi., the step of:
subjecting said isobaric beam of radioisotopes to a second focusing in second focusing equipment so as to produce a second focused beam.

29. A method according to claim 15, wherein said primary accelerator produces said low energy proton beam with beam currents of 100-250 microA, preferably 100-200 microA.

30. A method according to claim 15, wherein said source target comprises uranium dicarbide dispersed in a graphite substrate UCₓ.

31. A method according to claim 28, wherein said source target comprises uranium dicarbide dispersed in a graphite substrate UCₓ.
